(19) United States
(12) Patent Application Publication
(10) Pub. No.: US 2026/0241877 A1
(43) Pub. Date: Aug. 20, 2026

(54) LICENSE PLATE FRAME WITH INTERCHANGEABLE FRONT

(71) Applicant: Rachad Salem, Ramona, CA (US)

(72) Inventor: Rachad Salem, Ramona, CA (US)

(21) Appl. No.: 19/058,016

(22) Filed: Feb. 20, 2025

(51) Int. Cl. B60R 13/10

(52) U.S. Cl. CPC B60R 13/105

(57) ABSTRACT

A modifiable license plate frame for a vehicle. The frame has a base section. The base section has a plurality of attachment holes. It also has a base section magnetic section and a base section housing. The base section is rigidly connected to a vehicle. The license plate frame also has a removably attached front section. The front section has a magnetic section and a front section housing. Magnetic force attaches the base section to the front section. The base section magnetic section and the front section magnetic section are also contoured to ensure alignment between the front section and the base section. Alternate front sections with varying decorations may be attached.

The present invention relates to vehicles, and in particular, to license plate frames for vehicles.

### BACKGROUND OF THE INVENTION

License plates for vehicles are known in the prior art. License plates are necessary to identify a vehicle and its owner, allowing authorities to track a car if it's involved in an accident, crime, or other incident, and to verify that the vehicle is properly registered and insured; essentially acting as a unique identifier for each vehicle. In California, the following vehicles require a license plate: passenger vehicles (such as automobiles, sport utility vehicles and trucks), commercial motor vehicles, motorcycles, permanent trailers, trailer coaches, and park trailers.

There is no requirement to have a license plate frame. However, most vehicle owners prefer a license plate frame because the frame can be visually appealing as well as protect the condition and extend the life of the license plate.

FIG. 1 shows the rear end of automobile 1. License plate mounting bracket 2 is rigidly mounted to vehicle 1 as shown. License plate mounting bracket includes four threaded license plate bolt holes 7 as shown. The spacing of bolt holes 7 are standard. Horizontal spacing is 7 inches between the center of the left-side and right-side bolt holes. Vertical spacing is 4 ¾ inches between the center of the upside and downside bolt holes.

FIG. 2 shows prior art license plate 3. License plate 3 is approximately 12 inches x 6 inches and includes bolt pass-through holes 9 spaced to coincide with bolt holes 7 of mounting bracket 2.

FIG. 3 shows license plate 3 mounted without a frame. Bolts 11 have been inserted through pass-through holes 9 and threaded into bolt holes 7 of mounting bracket 2.

FIG. 5 shows license plate 3 mounted to mounting bracket 2 with a license plate frame. FIG. 4 shows prior art license plate frame 13. License plate frame 13 includes pass-through holes 15. In FIG. 5, bolts 11 have been inserted through pass-through holes 15 and 9 and threaded into bolt holes 7 of mounting bracket 2.

Prior art license plate frames have been available for many years and are effective. However, once installed the frames are seldom changed. They can become weathered and old and detract from the appearance of the vehicle.

Neodymium magnets are extremely strong permanent magnets. They are lightweight and used in a variety of applications.

What is needed is a better license plate frame in which the appearance of the frame can be easily updated and modified.

### SUMMARY OF THE INVENTION

The present invention provides a modifiable license plate frame for a vehicle. The frame has a base section. The base section has a plurality of attachment holes. It also has a base section magnetic section and a base section housing. The base section is rigidly connected to a vehicle. The license plate frame also has a removably attached front section. The front section has a magnetic section and a front section housing. Magnetic force attaches the base section to the front section. The base section magnetic section and the front section magnetic section are also contoured to ensure alignment between the front section and the base section. Alternate front sections with varying decorations may be attached.

### BRIEF DESCRIPTION OF THE DRAWINGS

FIGS. 1 – 5 show prior art license plates and method of attachment to a vehicle.

FIGS. 6 – 10 shows a preferred embodiment of the present invention.

FIGS. 11 – 14 show a method for utilizing a preferred embodiment of the present invention.

### DETAILED DESCRIPTION OF THE PREFERRED EMBODIMENTS

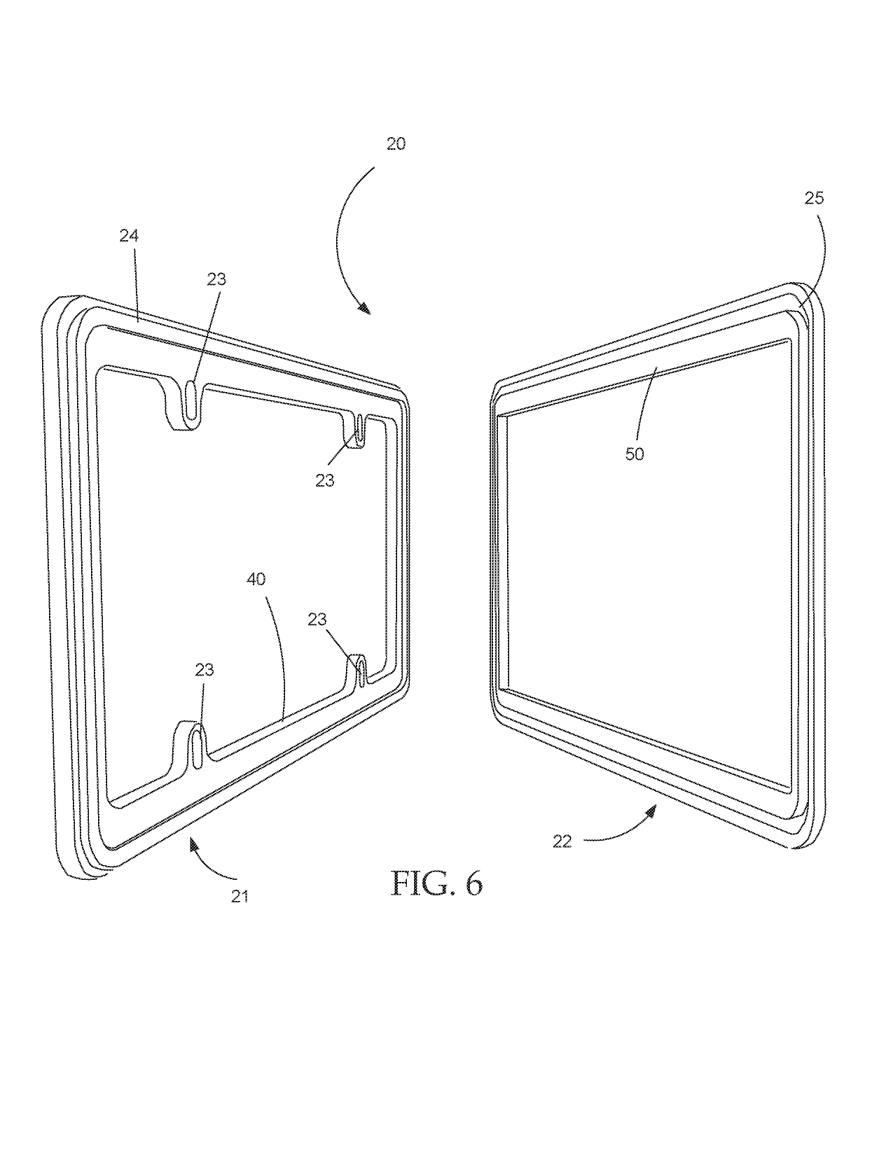

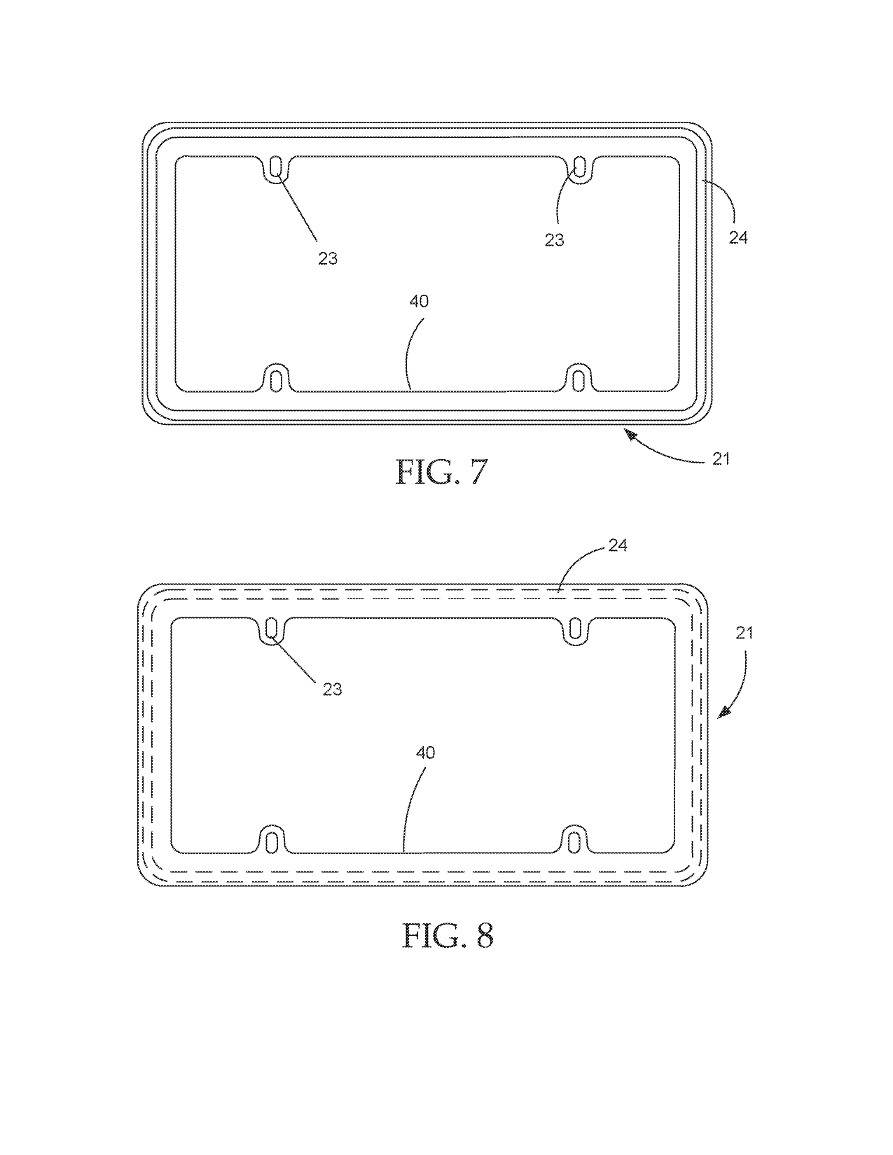

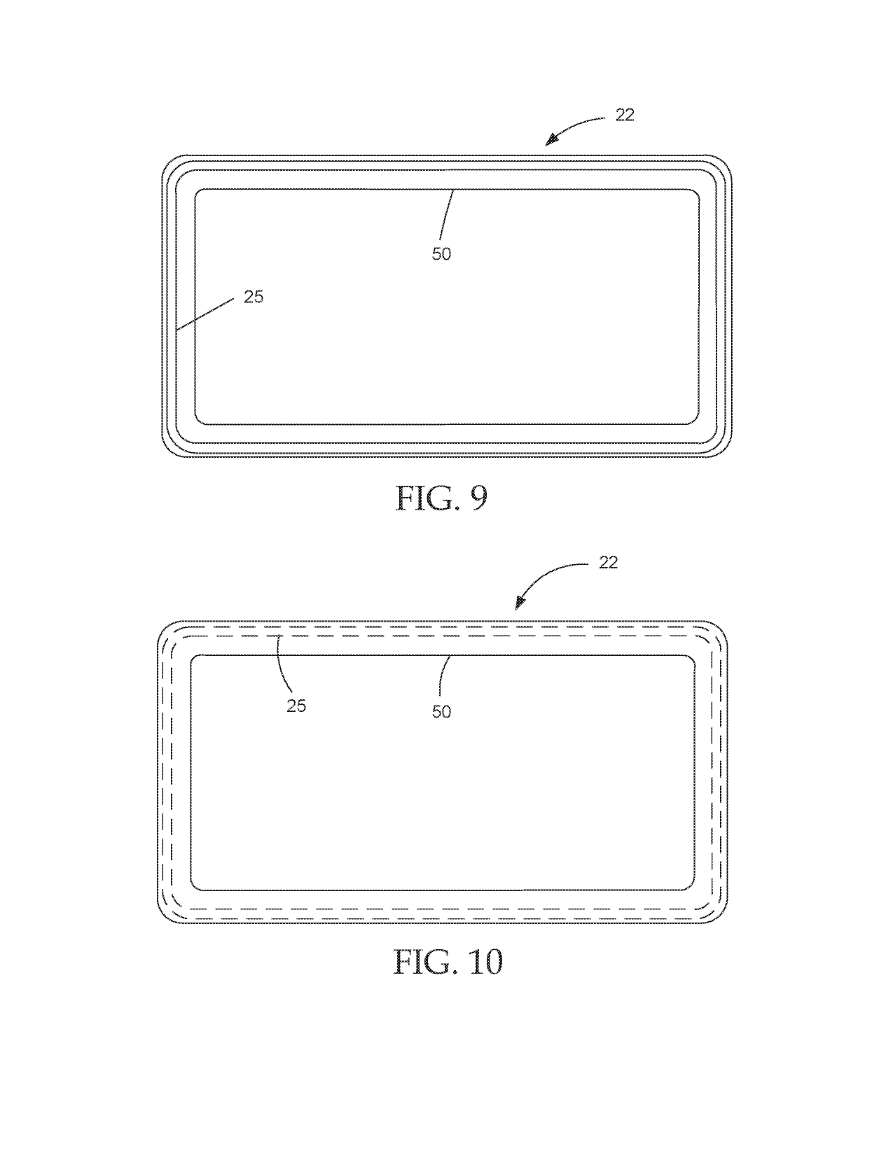

FIG. 6 shows a perspective view of interchangeable frame 20. FIGS. 7 and 8 show a front and back view of base section 21 and FIGS. 9 and 10 show a front and back view of removable front section 22. Interchangeable frame 20 includes mountable base section 21 and removable front section 22. Base section 21 includes 4 pass-through holes 23. Holes 23 are spaced to coincide with bolt holes 7 of mounting bracket 2. Both base section 21 and front section 22 are approximately 12 inches by 6 inches to coincide with the dimensions of license plate 3. Base section 21 includes magnetic extension strip 24 and front section 22 includes magnetic indentation strip 25. Base section 21 includes base section housing 40. Preferably, base section housing 40 is fabricated from aluminum for durability and corrosion resistance. Front section 22 includes housing 50. Preferably housing 50 is fabricated from plastic, for cost efficiency and durability. Magnetic extension strip 24 extends outward approximately ¼ inch and magnetic indentation strip 25 extends inward approximately ¼ inch. In a preferred embodiment magnetic extension strip 24 and magnetic indentation strip 25 are both fabricated from neodymium iron to achieve very high magnetic strength.

### Mounting the Frame

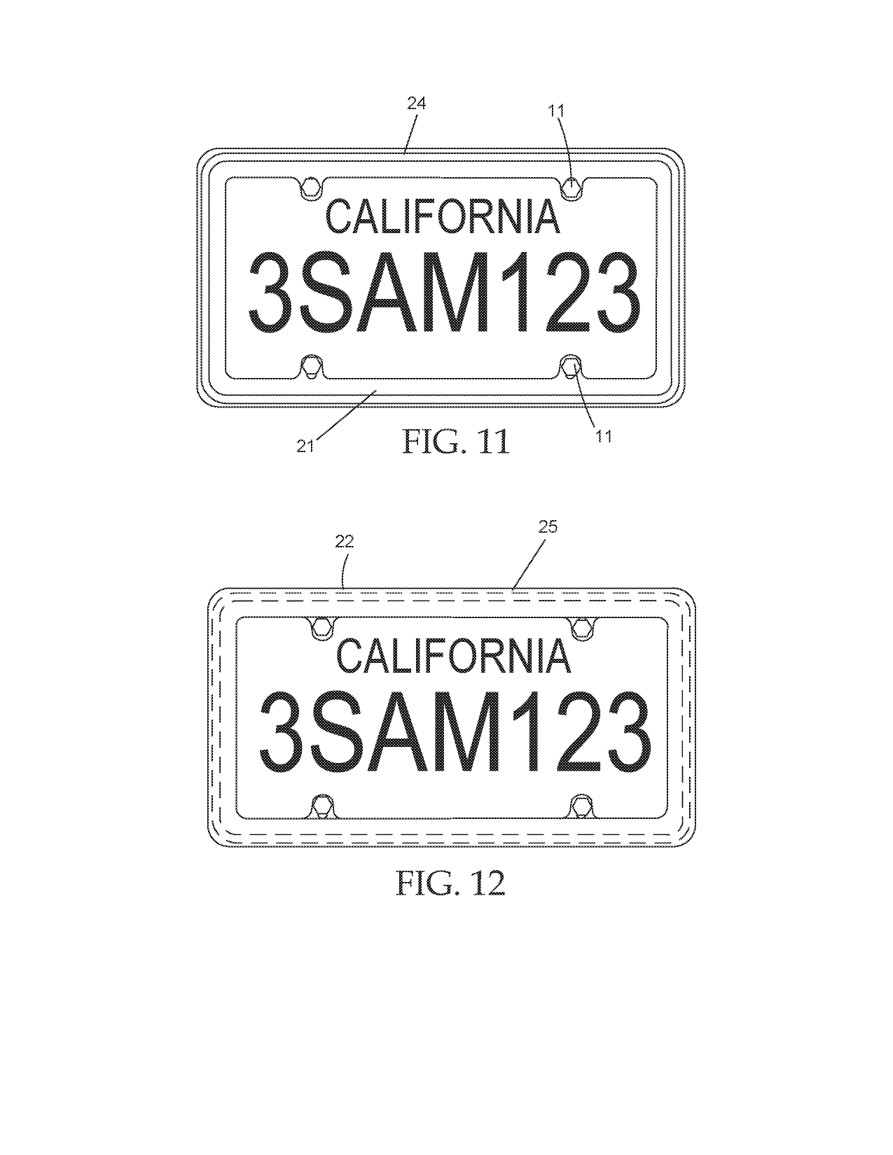

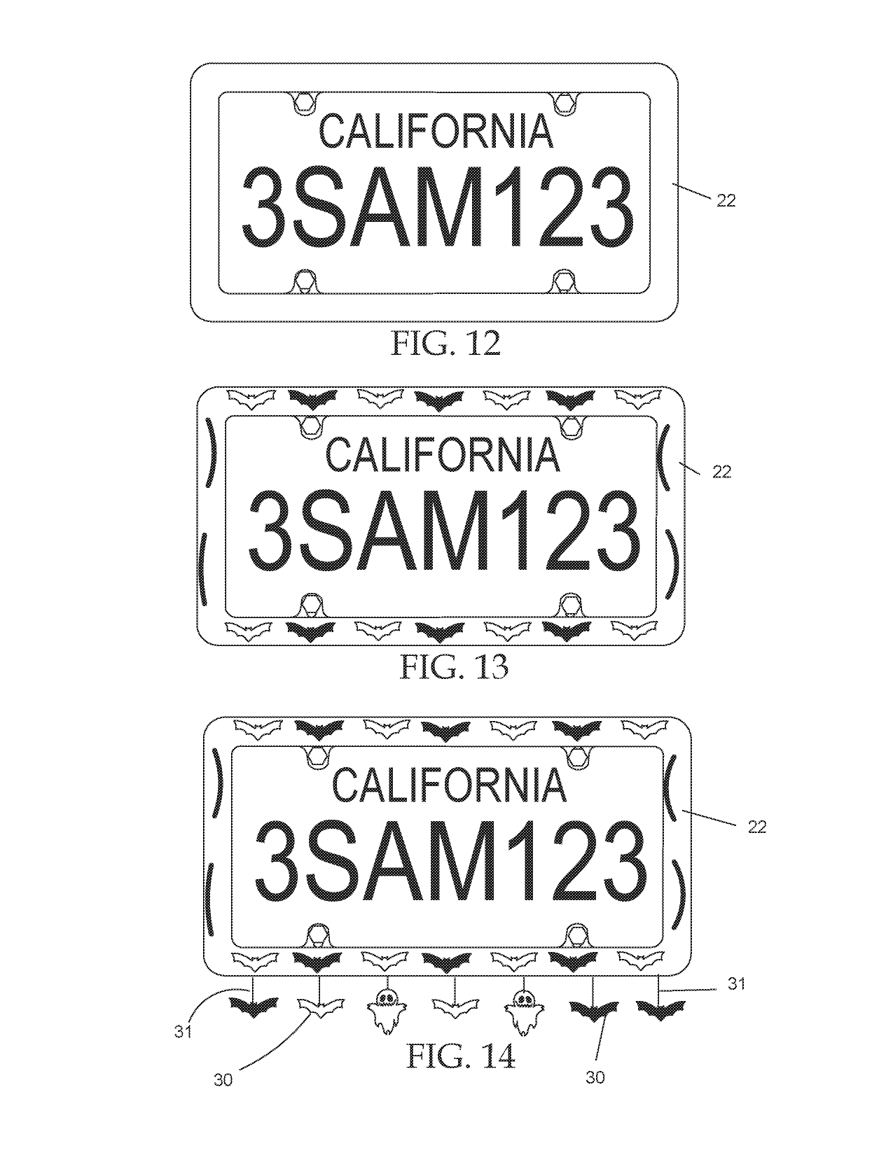

FIGS. 11-12 show a method for mounting license plate 3 to mounting bracket 2 with license plate interchangeable frame 20.

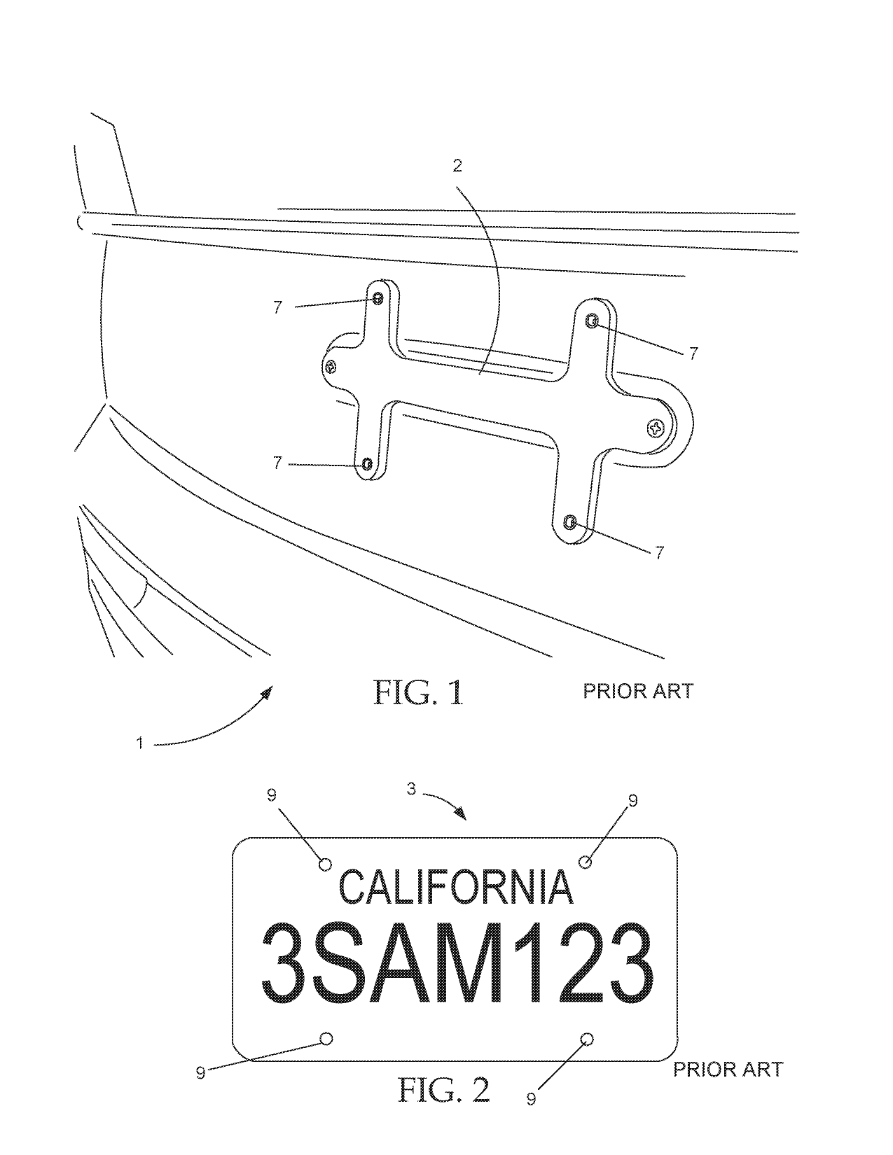

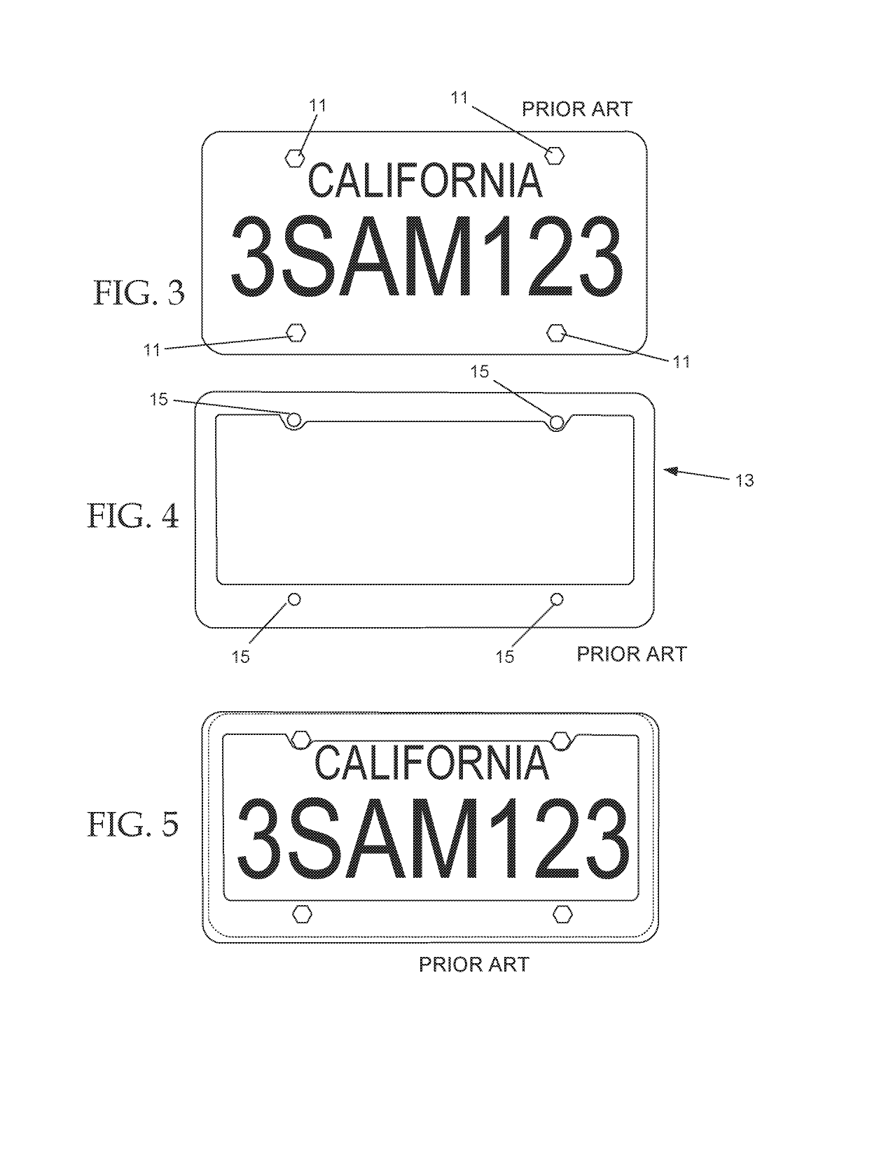

As shown in FIG. 11 first the user mounts base section 21. In FIG. 11, bolts 11 have been inserted through pass-through holes 23 (FIG. 9) and 9 (FIG. 2) and threaded into bolt holes 7 of mounting bracket 2 (FIG. 1).

Once base section 21 is mounted the user can then attach front section 22. In FIG. 12, the user has placed front section 22 over base section 21 and has aligned magnetic extension strip 24 with magnetic indentation strip 25. The very strong magnetic force between strip 24 and strip 25 draws front section 22 tightly close against base section 21. The magnetic connection of the strips 24 and 25 ensure that front section 22 is properly aligned over base section 21.

A feature of interchangeable frame 20 is the front section 22 may be easily replaced as desired by the user. For example, while base section 21 is mounted to bracket 2, a user may easily pull front section 22 away from base section 21 so that base section 21 appears as shown in FIG. 9. Then, the user can attach a new front section 22 that is decorated according to the user’s wishes.

For example, in FIG. 12 the user has attached front section 22 that is the same color as the vehicle it is mounted to.

In FIG. 13, the user has attached a front section 22 that is decorated with bats to celebrate Halloween.

In FIG. 14, the user has attached a front section 22 that has further attachments 30 connected by string 31.

While the present invention has been described in terms of preferred embodiments, the reader should consider these described embodiments only as particular embodiments. Many other embodiments are possible. Therefore, the reader should determine the scope of the present invention by the claims and their legal equivalents.

What is claimed is:

1. A modifiable license plate frame for a vehicle, comprising:
A. a base section comprising:
i. a plurality of attachment pass-through holes,
ii. a base section magnetic section, and
iii. a base section housing,
wherein said base section is rigidly mounted to a vehicle,
B. a front section comprising:
i. a front section magnetic section, and
ii. a front section housing,wherein said front section is removably attached to said base section, wherein said base section magnetic section and said front section magnetic section are attached via magnetic force, wherein said base section magnetic section and said front section magnetic section are contoured to ensure alignment between said front section and said base section.

2. The modifiable license plate frame as in claim 1, where said plurality of attachment pass-through holes are in alignment to coincide with vehicle mounting bracket attachment holes.

3. The modifiable license plate frame as in claim 1, wherein said base section magnetic section is a magnetic extension strip extending outwards from said base section housing.

4. The modifiable license plate frame as in claim 1, wherein said base section housing is fabricated from aluminum.

5. The modifiable license plate frame as in claim 1, wherein said front section magnetic section is a magnetic indentation strip extending inwards from said front section housing.

6. The modifiable license plate frame as in claim 1, wherein said front section housing is fabricated from plastic.

7. The modifiable license plate frame as in claim 1, wherein said front section is decorated.

8. The modifiable license plate frame as in claim 1, wherein said front section comprises decorative attachments connected by a string.
